(19) United States
(12) Patent Application Publication
(10) Pub. No.: US 2026/0150000 A1
(43) Pub. Date: May 28, 2026

(54) TCP TRAFFIC LATENCY IMPROVEMENT

(71) Applicant: HEWLETT PACKARD ENTERPRISE DEVELOPMENT LP, Spring, TX (US)

(72) Inventors: Zhenlei Wang, Beijing (CN); Xuguang Jia, Beijing (CN); Yongchang Guo, Beijing (CN)

(21) Appl. No.: 18/958,227

(22) Filed: Nov. 25, 2024

(51) Int. Cl. H04W 28/02; H04L 5/00; H04L 43/0876

(52) U.S. Cl. CPC H04W 28/0273; H04L 5/0053; H04L 43/0876

(57) ABSTRACT

The present disclosure proposes a solution of improving the TCP traffic latency for a station (STA) Multi-Link Device (MLD). The method can identify the TCP traffic of the STA MLD and obtain a traffic behavior of the STA MLD, and the traffic behavior of the STA MLD includes at least the size evaluation of the TCP traffic of the STA MLD, etc. Through collecting information of the number of available links and whether the link(s) of the STA MLD is proper for latency sensitivity traffic flow, the method can estimate the links of the STA MLD and obtain link health information. And the method can determine the TCP transmission mode for the STA MLD based on the traffic behavior and the link health information. Finally, the method transmits the traffic of the STA MLD based on the determined mode. In this way, the TCP traffic latency can be improved.

### BACKGROUND

In the field of Wi-Fi, Wi-Fi 7 (i.e., Institute of Electrical and Electronics Engineers (IEEE) 802.11be) is a Wi-Fi standard. In Wi-Fi 7, it enables devices to simultaneously send and receive data across different frequency bands and channels. With Multi-Link Operation (MLO), Wi-Fi 7 supports establishing multiple links between the Wi-Fi access point (AP, such as a router) and the Station (STA, such as a smartphone).

In Wi-Fi 7, a wireless access point (AP) in Wi-Fi 7 has the features of extreme transmission speed, low latency, high concurrent connections, etc. A station (STA) multi-link device (MLD) is also able to transmit and receive data over multiple links at the same time, thereby improving network throughput, reducing latency, and enhancing the reliability of data transmission. Further, an STA MLD does not necessarily always require multiple links on multiple frequency bands (such as 2.4 gigahertz (GHz), 5 GHZ, and 6 GHZ). Wi-Fi 7 supports single-link/single-radio non-AP MLD, which allows operation on multiple links, but only receives or transmits frames on one link at a time.

### BRIEF DESCRIPTION OF THE DRAWINGS

Implementations of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with reference to the following figures.

FIG. 1 illustrates an example network environment in which example implementations of the present disclosure may be implemented;

FIG. 2 illustrates the detailed structures of an STA MLD and an AP MLD;

FIG. 3 illustrates a schematic diagram showing a method for improving the TCP traffic delay of STA MLD according to multiple embodiments of the present disclosure;

FIG. 4 illustrates a flow chart of a method for improving the TCP flow delay of STA MLD based on flow evaluation according to multiple embodiments of the present disclosure;

FIG. 5 a schematic diagram of a method for improving the TCP traffic delay of STA MLD based on link health according to some other embodiments of the present disclosure;

FIG. 6 illustrates a schematic diagram of a method for improving the TCP traffic delay of STA MLD based on good link health according to some other embodiments of the present disclosure;

FIG. 7 illustrates a schematic diagram of a method for improving the TCP traffic delay of STA MLD based on poor link health according to some other embodiments of the present disclosure;

FIG. 8 illustrates a schematic diagram of the TCP transmission process of the MLSR (Multi-Link Single Radio) and the improvement according to multiple implementations of the present disclosure;

FIG. 9 illustrates a schematic diagram of the TCP transmission process of the EMLSR (Enhanced Multi-Link Single Radio) and the improvement according to multiple implementations of the present disclosure; and

FIG. 10 illustrates an example AP MLD according to implementations of the present disclosure.

### DETAILED DESCRIPTION

Wi-Fi 7 with the MLO technology can aggregate multiple channels on different frequency bands at the same time, which can negotiate seamless network traffic even if there is interference or congestion. With the MLO, Wi-Fi 7 can establish multiple links between an STA and an AP. Connecting to the 2.4 GHZ, 5 GHZ, and 6 GHz bands simultaneously can increase the throughput, reduce the latency, and improve reliability. For the purpose of brevity, in the present disclosure, an AP, an STA, or a client that supports the MLO feature, may each be referred to as an MLD, unless otherwise specified. For example, an access point hereafter may be referred to as an AP MLD, and a station multi-link device may be referred to as an STA MLD, which both support the MLO feature.

Generally speaking, the Transmission Control Protocol (TCP) provides reliable transmission in the network. The retransmission process relies on the sequence number and acknowledgment number in the TCP header to determine whether to retransmit based on the TCP ACK frame receiving in a certain time, and thus the speed of the TCP ACK reply has a great impact on the latency factor of the TCP traffic session.

Traditionally, the TCP traffic and TCP acknowledgement (ACK) frames exchange on a single link, there's no specific feature or mechanism to speed up the TCP ACK reply from an STA MLD. Even with Orthogonal Frequency Division Multiple Access (OFDMA), high TCP latency could still be an issue because TCP ACK frames significantly influence the overall TCP latency. Taking the downlink TCP transmission as an example, a TCP session of the TCP transmission process in the Wi-Fi network is in half-duplex transmission mode on a same link, the AP can start the next TCP session only after receiving the ACK signal from the STA transmitted on the same link, which greatly reduces the transmission efficiency.

However, in the new Wi-Fi 7 protocol, the MLO (Multi-Link Operation) function is introduced. Multiple links can exist between AP and STA MLD for data transmission. The MLO function provides a more flexible method than before to optimize TCP traffic delay, but there is currently no specific solution for TCP traffic under MLO. The present disclosure creatively proposes an optimized TCP traffic transmission solution to ensure better improvement of TCP traffic delay in Wi-Fi 7 MLO.

Therefore, the present disclosure optimizes the TCP traffic in Wi-Fi 7 by strategically scheduling specific uplink and downlink TCP traffic across the same or different links. For latency-sensitive TCP traffic, the present invention assigns different TCP flows to the same or different links to accelerate TCP acknowledgement (ACK) responses within the MLD framework. The present invention proposes a method for improving the TCP traffic latency for a station (STA) Multi-Link Device (MLD). With the assistance of DPI (Deep Packet Inspection) technology etc., the method can identify the TCP traffic of the STA MLD and obtain a traffic behavior of the STA MLD, and the traffic behavior of the STA MLD includes at least the size evaluation of the TCP traffic of the STA MLD etc. Through collecting information of the number of available links and whether the link(s) of the STA MLD is proper for latency sensitivity traffic flow, the method can estimate the links of the STA MLD and obtain link health information. After obtaining the traffic behavior of the STA MLD and the link health information, the method can determine the TCP transmission mode for the STA MLD based on the traffic behavior and the link health information. And the method at least determines the number of links used for the traffic of the STA MLD and what traffic should be transmitted through which link. Finally, the method transmits the traffic of the STA MLD based on the determined mode.

Alternatively, the present disclosure optimizes transmission control protocol (TCP) traffic in Wi-Fi 7 by strategically scheduling specific uplink and downlink TCP traffic on the same or different links. For delay-sensitive TCP traffic, the present disclosure allocates different TCP traffic to the same or different links to accelerate TCP acknowledgment (ACK) responses within the MLD framework. Therefore, the TCP traffic of the STA MLD can be improved, and the latency can be reduced by transmitting the traffic of the STA MLD through the selected proper TCP transmission mode for the STA MLD.

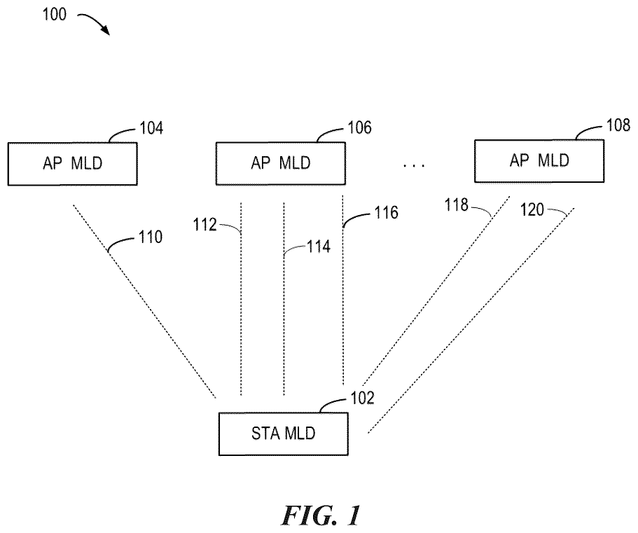

The advantages of implementations of the present disclosure will be described with reference to example implementations as described below. Reference is made below to FIG. 1 through FIG. 10 to illustrate basic principles and several example implementations of the present disclosure herein.

Reference is made to FIG. 1, which illustrates an example network environment 100 in which example implementations of the present disclosure may be implemented. As shown in FIG. 1, the network environment 100 may comprise an STA MLD 102, an AP MLD 104, an AP MLD 106, and an AP MLD 108. Any of the AP MLD 104, the AP MLD 106, and the AP MLD 108 may operate on the 2.4 GHz band. Any of the AP MLD 104, the AP MLD 106, and the AP MLD 108 may further operate on the 5 GHz band. Any of the AP MLD 104, the AP MLD 106, and the AP MLD 108 may further operate on the 6 GHz band. The STA MLD 102 may operate on the 2.4 GHz band. The STA MLD 102 may further operate on the 5 GHz band and the 6 GHz band as well as any of the AP MLD 104, the AP MLD 106, and the AP MLD 108.

The network environment 100 may further comprise one link, two links, or three links, etc. between each AP MLD and the STA MLD 102. For example, these links may include a link 110 between the AP MLD 104 and the STA MLD 102 as shown in FIG. 1. The link 110 may operate on the 2.4 GHz frequency band.

For another example, these links may further include a link 112, a link 114, and a link 116 between the AP MLD 106 and the STA MLD 102 as shown in FIG. 1. The link 112 may operate on the 2.4 GHz frequency band. The link 114 may operate on the 5 GHz frequency band, and the link 116 may operate on the 6 GHz frequency band.

For a further example, these links may further include a link 118 and a link 120 between the AP MLD 108 and the STA MLD 102 as shown in FIG. 1. The link 118 may operate on the 5 GHz frequency band, and the link 120 may operate on the 6 GHz frequency band.

Further, it is to be understood that the number of AP MLDs, the number of STA MLDs, and the number of links are not limited to what they are shown in FIG. 1. The layout and arrangement of the STA MLD and the AP MLDs are not limited to what they are shown in FIG. 1. It is to be understood that for the purposed of simplification, the term “link” and the term “band” may be used interchangeably throughout the present disclosure.

In the network environment 100, the STA MLD 102 may be a multi-link multi-radio device, which means it can receive or transmit frames via multiple links at the same time. The STA MLD 102 may also be a multi-link single radio (MLSR) device, which means it has multiple links, but it receives or transmits frames on a single link at a time.

The STA MLD 102 may assess the surrounding AP MLDs to choose an AP MLD with the best channel quality, the most stable signals, the fastest speed, the best channel utility, or the like (can be collectively referred to as performance). For example, the STA MLD 102 may select the AP MLD 104 as the best candidate AP MLD to be connected to. The factors for assessing an AP MLD in Wi-Fi 7 are more than in Wi-Fi 6 because there is more than one link that can be used for data transmission at a time. When the STA MLD 102 tries to find out the best candidate AP, all links should be considered. Moreover, because there are more links, which means more channels, the time for channel discovery should be more efficient for time-saving.

In some example implementations, the STA MLD 102 may obtain the basic link information of the neighbor AP MLD, for example, the AP MLD 104, the AP MLD 106, and the AP MLD 108, from beacon/probe respond frames via a passive scanning process (for example, listening beacons or probe frames on the links) on all the links comprising the link 110, the link 112, the link 114, the link 116, the link 118 and the link 120. Then, the STA MLD 102 may establish a candidate table. The candidate table may comprise each AP MLD and its corresponding working channel/band information. For example, the AP MLD 104 may have channel A on the link 110, the AP MLD 106 may have channel B on the link 112, the AP MLD 106 may have channel C on the link 114, and the AP MLD 106 may have channel D on the link 116. The AP MLD 108 may have channel E on the link 118, and the AP MLD 108 may have channel F on the link 120. It is to be understood that there could be more channels on a link.

In some example implementations, the STA MLD 102 may create another candidate table for scanning. The other candidate table may comprise the link/band, its corresponding channels, and its corresponding AP MLDs. For example, the 2.4 GHz band (the link 120 and the link 112) may have channel A and channel B. The 5 GHz band (the link 114 and the link 118) may have channel C and channel E. The 6 GHz band (the link 116 and the link 120) may have channel D and channel F.

Then, the STA MLD 102 may obtain and verify complete information on all AP MLDs' Media Access Control (MAC) information and physical information via an active scanning process. The STA MLD 102 may send a multi-link (ML) probe request frame on the links to obtain and verify the whole ML information.

The STA MLD 102 may double check the status of each link. The STA MLD 102 may need to scan the other links to cross check if this link actually exists even though it may know this link information from a reduced neighbor report (RNR) and per-STA profile information from an ML probe. The STA MLD 102 may obtain RSSI information via a periodic scanning process on per-link for each of the AP MLD 104, the AP MLD 106, and the AP MLD 108.

After obtaining the MAC information, the physical information, and the RSSI information on each active channel of the active links, the STA MLD 102 may compute a metric of each AP MLD that considers the above factors as a whole. This metric may be called the path cost herein. Usually, the AP MLD with the smallest path cost may be selected as the best candidate AP MLD. In this way, the efficiency and accuracy of an STA MLD to evaluate the quality of neighbor AP MLDs can be improved.

It is to be understood that in FIG. 1 and throughout the present disclosure, the number of any elements is only for the purpose of illustration without suggesting any limitations. The network environment 100 may comprise more or fewer links, and the AP MLDs and the STA MLD 102 may support more links as Wi-Fi technology develops in the future.

Considering that how the STA MLD 102 selects different AP MLDs and the links therebetween for transmission is not the focus of the present disclosure, in order to make the description of the present disclosure more concise, multiple embodiments of the present disclosure are described by taking two links as an example. In some implementations of the present disclosure, the links 118 and 120 between the STA MLD 102 and the AP MLD 108 are selected by the STA MLD 102.

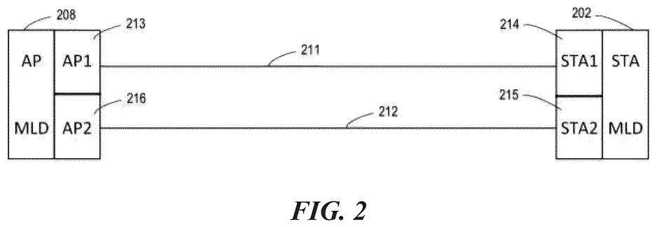

FIG. 2 shows the detailed structures of the STA MLD 202 and the AP MLD 208. There are two links 211 and 212 between the STA MLD 202 and the AP MLD 208, and the AP MLD 208 includes an AP1 213 and an AP2 216, and the STA MLD 202 includes an STA1 214 and an STA2 215. The link 211 is between the STA1 214 and the AP1 213, and the link 212 is between the STA2 215 and the AP2 216. Multiple implementations of the present disclosure will be described based on the AP-STA structure shown in FIG. 2.

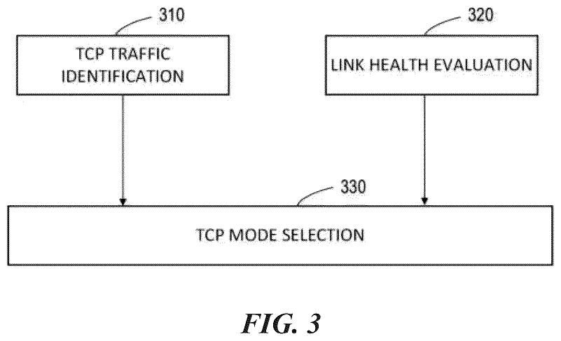

Reference is made to FIG. 3, which is a schematic diagram showing a method for improving the TCP traffic delay of STA MLD according to multiple embodiments of the present disclosure.

In the present disclosure, TCP traffic in Wi-Fi MLD is optimized by strategically scheduling specific uplink and downlink TCP traffic on the same or different links. For delay-sensitive TCP traffic, different TCP traffic can be assigned to the same or different links to accelerate TCP ACK responses within the MLD framework. Alternatively, it includes identifying TCP traffic and estimating links suitable for TCP transmission, and selecting a strategy for efficient TCP traffic transmission mode on MLD.

As shown in FIG. 3, in block 310, in order to optimize the transmission of TCP ACK frames in Wi-Fi 7 MLO scenarios, especially when selecting a better low-latency link, a specific strategy can be implemented to ensure minimum latency. In order to identify the TCP traffic of STA MLD to obtain the traffic behavior of STA MLD, wherein the traffic behavior of STA MLD at least includes the size evaluation of the TCP traffic of STA MLD, it is necessary to identify the TCP traffic and the identification of TCP ACK frames. Before performing TCP traffic optimization, the present disclosure requires identifying the required TCP traffic between the STA MLD 220 and the AP MLDs 208. There are many ways for the application (APP) logic upper layer to identify TCP traffic sessions. For example, custom commands may be used to set specific TCP session information (5-tuple, QOS (quality of service) requirements, etc.) for drivers with specific delay requirements, or the DPI (deep packet inspection) function may also be leveraged for the purpose. With the help of DPI technology, it may gain a deeper understanding of client traffic. With the help of DPI, it may have a broader understanding of STA client behavior and customize better TCP delay guarantee optimization methods. Among them, all traffic behavior characteristics identified as target TCP traffic can be applied to subsequent TCP traffic mode selection, and both the application (APP) and the driver can perform QOS priority mapping logic control according to the selected TCP traffic mode. In other words, the TCP traffic can be controlled in mode by the upper-layer software, which greatly improves the operability and interface friendliness of multiple embodiments of the present disclosure.

In the method shown in FIG. 3, at block 320, the health of the links 211, 212 may be further evaluated. The TCP ACK frame can be transmitted along with other TCP traffic or by itself over another link of the MLD, and some techniques and tools have introduced link health/quality indicators to help indicate whether the link/band is suitable for high-performance or delay-sensitive traffic. Therefore, to save the space of this disclosure, this disclosure will not discuss in depth how to select a suitable link as the transmission path for TCP ACK and TCP traffic. Any technique or tool suitable for evaluating the health of a link, whether existing or emerging in the future, may be applied to this disclosure without affecting the scope of protection of this disclosure. Alternatively, the following method can be used to evaluate the link health of the MLD. Many factors can indicate the link health, which may include the number of clients, channel busyness, TX (transmit data)/RX (receive data) retry rate, aggregation errors, and radio MAC (media access controller)/PHY (physical layer interface) errors or reset counters. It may periodically calculate the status of each link and then use the result for link selection.

In some implementations of the present disclosure, assuming Fₙ stands for a link health evaluation method (its specific implementation is not the focus of discussion in this disclosure, so it is only introduced into this disclosure to illustrate the feasibility of this disclosure) and Lₕ for link health, it can get bellowing formula (1) to evaluate the link health of the links 211 or 212:

$${L}_{h} ( tp , lt ) = {F}_{n} ( CN , CB , RR , RS , SC … ) \qquad ( 1 )$$

Wherein the input of the function Fₙ includes at least one of client number (CN), channel busy (CB), retry rate (RR), radio state (RS), STA capability (SC) etc., and the output of the function Fₙ includes at least one of throughput score(tp) or link latency score(It), etc. Based on the formula (1), by obtaining the status of the above-mentioned input and output parameters of the link, the link health status can be evaluated, thereby the link health information may be obtained. Optionally, the link health information of links 211 and 212 at least includes the number of links and whether the link is suitable for delay-sensitive traffic.

At block 330, based on the identified TCP traffic and the obtained link health information evaluation, the TCP transmission mode may be selected according to the methods provided by the multiple embodiments of the present disclosure. And, based on the selected TCP transmission mode, the TCP traffic to be transmitted may be transmitted according to the methods provided by the multiple embodiments of the present disclosure. Thereby, the TCP traffic of the STA MLD can be improved and the delay can be reduced. As for how to select the TCP transmission mode and how to transmit the TCP traffic to be transmitted based on the selected TCP transmission mode, the present disclosure will be described in detail in the subsequent multiple embodiments.

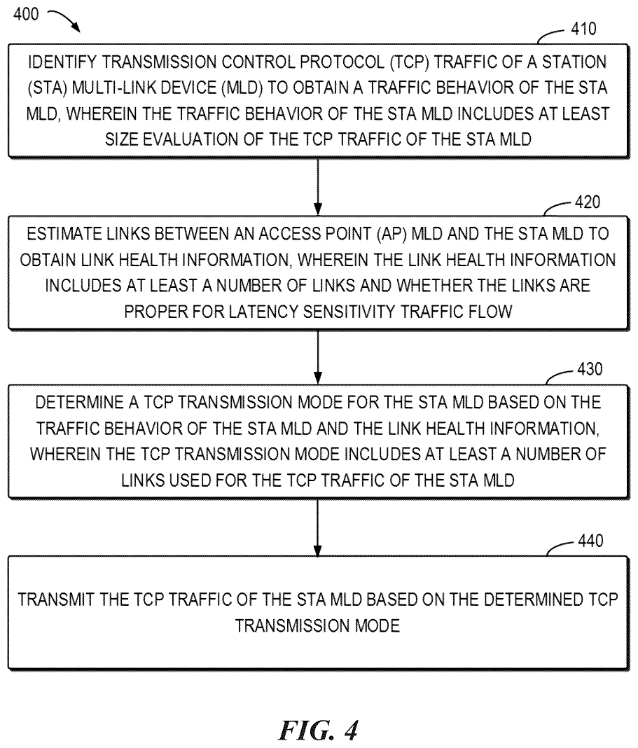

Now referring to FIG. 4, FIG. 4 shows a flow chart of a method 400 for improving the TCP flow delay of STA MLD based on flow evaluation according to multiple embodiments of the present disclosure. At block 410, the TCP traffic of the STA MLD may be identified to obtain a traffic behavior of the STA MLD, and the traffic behavior of the STA MLD may include at least size evaluation of the TCP traffic of the STA MLD. Alternatively, in order to obtain the traffic behavior of the STA MLD, one embodiment of the present disclosure may provide a deep insight method for the TCP flow. The deep insight method may inspect the TCP traffic between the AP MLD and the STA MLD. Those skilled in the art may use any DPI tool suitable for the present invention to monitor TCP traffic. The present disclosure does not limit any form of DPI tool, as long as it is suitable for use in various embodiments of the present disclosure. The use of any kind of DPI tools should fall within the scope of protection of the present disclosure. In addition, the deep insight method may obtain the traffic behavior of the STA MLD based on the inspection. Optionally, the deep insight method may further determine a size of the TCP traffic of the STA MLD based on the obtained traffic behavior of the STA MLD.

On the other hand, in order to obtain the traffic behavior of the STA MLD, one embodiment of the present disclosure may provide another method for identifying the TCP traffic. The method may set TCP session information with a latency requirement to obtain the traffic behavior information through custom commands. This is, the skilled person in the art may use customized commands to set specific TCP session info (e.g. 5-tuple, QOS requirement, etc.) to a driver with specific latency requirements and then obtain the traffic behavior of the STA MLD.

At block 420, the links between an Access Point (AP) MLD and the STA MLD may be estimated to obtain link health information, and the link health information may include at least a number of links and information about whether the links are proper for latency sensitivity traffic flow. In order to estimate the links between an AP MLD and the STA MLD to obtain link health information, one embodiment of the present disclosure may provide an evaluation method. Alternatively, the evaluation method may determine the number of links between the AP MLD and the STA MLD available for the TCP traffic. The method may check the links between the AP MLD and the STA MLD respectively, and record the links available for the TCP traffic. Alternatively, after determining the number of links, the evaluation method may further check whether the links are proper for latency sensitivity traffic flow to obtain the link health information. Alternatively, the method may further check whether the links are proper for high-performance traffic flow to obtain more health information.

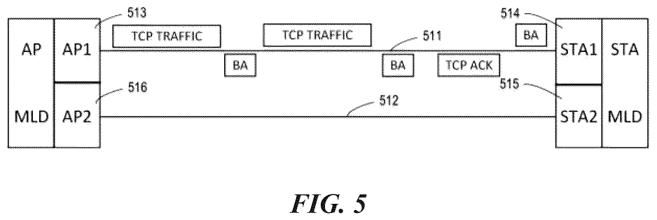

At block 430, A TCP transmission mode may be determined for the STA MLD based on the traffic behavior of the STA MLD and the link health information, and the TCP transmission mode may include at least a number of links used for the TCP traffic of the STA MLD. Also, at block 440, the TCP traffic of the STA MLD is transmitted based on the determined TCP transmission mode. As for how to select the TCP transmission mode and how to transmit the TCP traffic to be transmitted based on the selected TCP transmission mode, the present disclosure will be described in detail in the subsequent multiple embodiments in detail with reference to FIGS. 5-7.

FIG. 5 shows a schematic diagram of a method for improving the TCP traffic delay of STA MLD based on link health according to some other embodiments of the present disclosure, and the link 511 is between the STA1 514 and the AP1 513, and the link 512 is between the STA2 515 and the AP2 516. In FIG. 5, as an example, for the case of MLMR (Multi-Link Multi-Radio), FIG. 5 shows a strategy of using a single link to transmit TCP traffic, that is, TCP traffic is transmitted only on the link 511 between AP1 513 and STA1 514. When it is identified that the TCP traffic is small, this is, the traffic behavior of the STA MLD indicates the size the size of TCP traffic being less than a threshold, the threshold may be determined by the person skilled in the art, and it is evaluated that all other links are very busy as the health information of the links, the method may select only one link to transmit TCP traffic and TCP ACK, e.g. the link 511 as shown in FIG. 5. Because if a link is very busy, and still transmitting frames on the link, it may cause multiple retries or packet loss, and even results in greater delay.

In some implementations of the present disclosure, the transmission identifier TID (Transmission Identifier) in Wi-Fi 7 may be set for limiting one single link 511 to transfer the TCP traffic and TCP acknowledgement (ACK). The TID in Wi-Fi 7 is a field used to identify data streams in wireless communications, mainly used to indicate the priority and service quality of data streams. TID is used in the QoS data header of the Wi-Fi data frame to classify and manage different data streams. By using TID, Wi-Fi devices can schedule and process data streams according to different priorities and service quality requirements. For example, high-priority traffic can be sent first, while low-priority traffic can be postponed or discarded to ensure network performance and user experience. TID can help network devices maintain a certain transmission quality when transmitting large amounts of data, avoiding problems such as network congestion and data loss.

Therefore, based on the method provided by Wi-Fi 7, alternatively, the uplink TID (0-7) of the TCP traffic of all other links can be disabled through TID to link mapping negotiation to ensure that TCP ACK is transmitted on the selected single link 511, as shown in FIG. 5. In other words, the method may disable the TID of the TCP traffic of all other links except for the link 511 through TID-to-link mapping negotiation, and the method further transmitting the TCP traffic and the TCP ACK on the selected link 511.

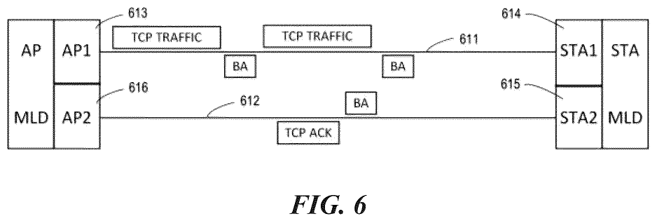

FIG. 6 shows a schematic diagram of a method for improving the TCP traffic delay of STA MLD based on good link health according to some other embodiments of the present disclosure, and the link 611 is between the STA1 614 and the AP1 613, and the link 612 is between the STA2 615 and the AP2 616. In FIG. 6, as an example, for the case of MLMR, FIG. 6 shows a strategy of transmitting TCP traffic on one link 611 and TCP ACK on another link 612. Among them, when it is identified that the traffic behavior is that the TCP traffic is small and the link health assessment result is that the multi-link is not busy, that is, the health evaluation is good, two or more different links 611, 612 may be selected for TCP traffic and TCP ACK transmission, which can ensure that the delay of TCP traffic is smaller and avoid conflicts caused by occupying the air interface.

By adopting the method shown in FIG. 6, a smaller delay can be further obtained. Specifically, based on the method provided by Wi-Fi 7, alternatively, TID to link mapping negotiation is used to guide TCP traffic/TCP ACK on different links as mentioned in details above. In other words, if the TCP traffic is less than a threshold and the link health information indicates all links being not busy, the method of FIG. 6 may select at least two links 611, 612, etc. to transmit the TCP traffic and TCP ACK. Alternatively, TXOP (Transmission Opportunity) sharing technology may also be leveraged for the method of FIG. 6, and the associated AP used to transmit TCP ACK may occupy the air interface for the target client to further shorten the delay of TCP ACK. Exemplarily, uplink/downlink Orthogonal Frequency Division Multiple Access (OFMDA) may be preferentially scheduled on the link processing TCP ACK to accelerate the sending of TCP ACK transmission as soon as possible to reduce delay.

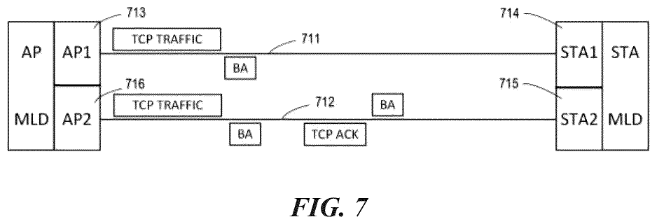

FIG. 7 shows a schematic diagram of a method for improving the TCP traffic delay of STA MLD based on poor link health according to some other embodiments of the present disclosure, the link 711 is between the STA1 714 and the AP1 713, and the link 712 is between the STA2 715 and the AP2 716. In FIG. 7, as an example, for the case of MLMR, FIG. 7 shows a strategy of transmitting DL (downlink) TCP traffic and UL (uplink) TCP ACK on multiple links respectively. When it is detected that the TCP traffic is large and/or both the links are very busy, that is, when the health assessment status of the link is poor, the method shown in FIG. 7 can utilize multiple links for load balancing/aggregation and reduce TCP traffic delay by effectively distributing traffic on all available links. Specifically, based on the method provided by Wi-Fi 7 described in detail above, optionally, all restrictions on TID to link mapping in both directions are released, that is, the restrictions on all TIDs are cancelled, and the system selects the link for transmission and whether to transmit TCP traffic or TCP ACK. FIG. 7 shows that TCP traffic and TCP ACK can be transmitted simultaneously in links 711 and 712, thereby improving transmission efficiency and reducing latency. Optionally, an upper-layer APP can be used for QOS control, such as the Aruba Air Slice/Air Express tool currently available on the market to select both links 711 and 712 to transmit TCP traffic and TCP ACK simultaneously.

In some implementations of the present disclosures, it may be assumed that the total number of links between the AP MLD and the STA MLS is a natural number n, and the following abbreviations and their meanings can be introduced to facilitate the description of the TCP traffic transmission mode selection strategy below: T_{UL}/T_{DL} mean Uplink/Downlink TCP traffic throughput value, and HR_{UL}/THR_{DL} mean TCP traffic throughput value thresholds, and Lis means the status of link i (busy status: 1 or not busy status: 0), wherein i=1, 2, . . . , n.

Based on the methods shown in FIGS. 5-7, the mode selection strategy adopted by the present disclosure can be represented by the following pseudo codes:

$If {T}_{UL} < {THR}_{UL} \&\& {T}_{DL} < {THR}_{DL} \&\& {\sum }_{i}^{n} {L}_{i \_ s} > ( n - 1 )$
Select the Case 1 // Select the mode shown in FIG. 5
$Else if {T}_{UL} < {THR}_{UL} \&\& {T}_{DL} < {THR}_{DL} \&\& {\sum }_{i}^{n} {L}_{i \_ s} \leq ( n - 1 )$
Select the Case 2 // Select the mode shown in FIG. 6
$Else if {T}_{U L} > {THR}_{U L} or {T}_{D L} > {THR}_{D L} or {\sum }_{i}^{n} {L}_{i \_ s} > ( n - 2 )$
Select the Case 3 // Select the mode shown in FIG. 7

Taking dual-link MLD as an example, the methods shown in FIGS. 5, 6, and 7 correspond to three situations for the transmission of TCP traffic. The Case 1 is related that TCP traffic, and TCP ACK transmission occur on the same link. This may be the worst case, with the lowest TCP efficiency, and should be avoided unless the second link is unavailable. And the Case 2 is related to that DL TCP traffic is transmitted on one link and UL TCP ACK is transmitted on another link. This situation is suitable for situations where the TCP traffic throughput value is small. Finally, the Case 3 is related to that DL TCP traffic and UL TCP ACK transmission occur on both links. This situation is suitable for situations where the TCP traffic throughput value is large. In this way, the present disclosure has considered different application scenarios and provided different modes for selection to overcome the disadvantages of these application scenarios. Therefore, the present disclosure can improve the TCP traffic latency greatly.

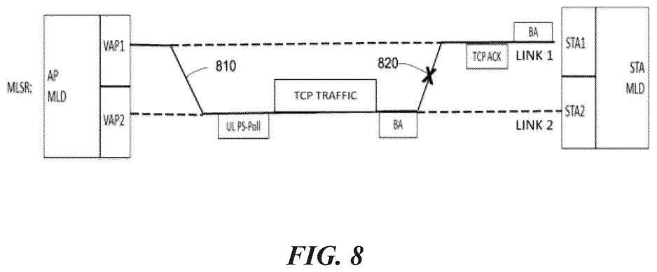

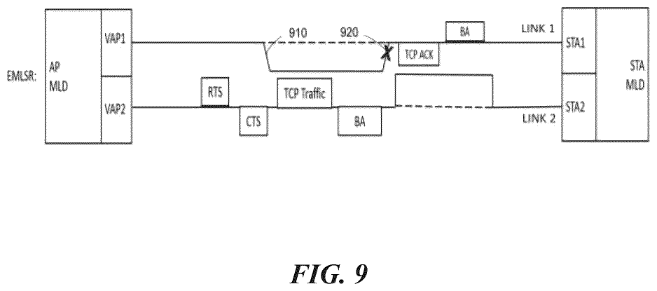

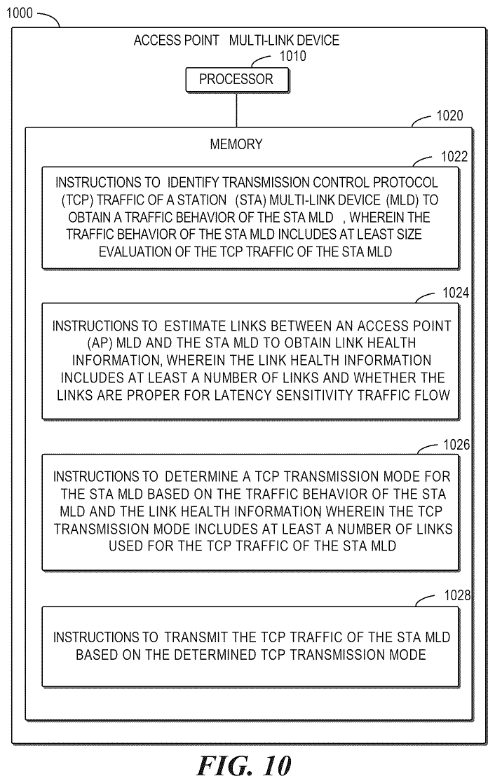

FIG. 8 shows a schematic diagram of the TCP transmission process of the MLSR (Multi-Link Single Radio) and the improvement according to multiple implementations of the present disclosure, and FIG. 9 shows a schematic diagram of the TCP transmission process of the EMLSR (Enhanced Multi-Link Single Radio) and the improvement according to multiple implementations of the present disclosure. For the case of MLSR shown in FIG. 8, whether it is MLSR or EMLSR shown in FIG. 10, if the link is switched (810, 910), there will be a delay time in the switching process between the links, which will make its performance worse than that of the traditional non-MLO client, and the TCP traffic delay will also increase. It can be seen from FIG. 8 and FIG. 9 that the TCP ACK is delayed by the conversion time during the switching process (810, 910). Therefore, it is necessary to select a more reliable link to transmit TCP traffic based on the evaluated link health information. Specifically, based on the method provided by Wi-Fi 7, other links are optionally disabled through TID to link mapping to avoid link switching time and reduce TCP traffic delay. Optionally, a false data buffer is indicated through TIM IE (Traffic Indication Map Enhanced Distributed Channel Access) in the beacon frame on the working link to ensure that the link is always used during TCP session transmission. In other words, the other links are disabled to avoid the switching and also avoid the switching delay as schematically shown in FIG. 8 and FIG. 9 at the disabling steps 820 and 920.

In this way, it is noteworthy that by mapping the selection strategy of the present disclosure to the MLO TCP traffic transmission according to the multiple embodiments of the present disclosure, it is possible to ensure efficient processing of TCP traffic under various network conditions, optimize latency and reduce TCP latency. This flexible approach can be dynamically adjusted based on the current status of all available links, and the present disclosure is explained here using exemplary implementations. It is by using the methods shown in FIGS. 4-7 that TCP ACK transmission can be optimized to ensure TCP traffic latency for Wi-Fi 7 MLO, thereby greatly improving the customer experience.

Reference is made to FIG. 10, which illustrates an example AP MLD 1000 according to implementations of the present disclosure. As shown in FIG. 10, the AP MLD 1000 comprises at least one processor 1010, and a memory 1020 coupled to the at least one processor 1010. The memory 1020 stores instructions 1022, 1024, 1026, and 1028 to cause the processor 1010 to perform actions according to example implementations of the present disclosure. As shown in FIG. 10, the memory 1020 stores instructions 1022 to identify Transmission Control Protocol (TCP) traffic of a station (STA) Multi-Link Device (MLD) to obtain a traffic behavior of the STA MLD, wherein the traffic behavior of the STA MLD includes at least size evaluation of the TCP traffic of the STA MLD. The memory 1020 further stores instructions 1024 to estimate links between the AP MLD and the STA MLD to obtain link health information, wherein the link health information includes at least a number of links and whether the links are proper for latency sensitivity traffic flow.

The memory 1020 further stores instructions 1026 to determine a TCP transmission mode for the STA MLD based on the traffic behavior of the STA MLD and the link health information, wherein the TCP transmission mode includes at least a number of links used for the TCP traffic of the STA MLD. The memory 1020 further stores instructions 1028 to transmit the TCP traffic of the STA MLD based on the determined TCP transmission mode. The stored instructions and the functions that the instructions may perform can be understood with reference to the description of FIGS. 2-7. For the purpose of simplification, the details of instructions 1022, 1024, 1026, and 1028 will not be discussed herein.

Similarly, by implementing the instructions 1022, 1024, 1026, and 1028, it is possible to ensure efficient processing of TCP traffic under various network conditions, optimize latency and reduce TCP latency. This flexible solution can be dynamically adjusted based on the current status of all available links, and the present disclosure is explained here using exemplary implementations. The TCP ACK transmission can be optimized to ensure TCP traffic latency for Wi-Fi 7 MLO, thereby greatly improving the customer experience. Other advantages of implementations will not be discussed again for the sake of simplification.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but is not limited to an electronic, magnetic, optical, electromagnetic, infrared, or semiconductor system, apparatus, device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order or that all illustrated operations be performed to achieve desirable results. In certain circumstances, multitasking and parallel processing may be advantageous. Certain features that are described in the context of separate implementations may also be implemented in combination in a single implementation. Conversely, various features that are described in the context of a single implementation may also be implemented in multiple implementations separately or in any suitable sub-combination.

In the foregoing Detailed Description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed is:

1. A method comprising:
identifying Transmission Control Protocol (TCP) traffic of a station (STA) Multi-Link Device (MLD) to obtain a traffic behavior of the STA MLD, wherein the traffic behavior of the STA MLD includes at least size evaluation of the TCP traffic of the STA MLD;
estimating links between an Access Point (AP) MLD and the STA MLD to obtain link health information, wherein the link health information includes at least a number of links and whether the links are proper for latency sensitivity traffic flow;
determining a TCP transmission mode for the STA MLD based on the traffic behavior of the STA MLD and the link health information, wherein the TCP transmission mode includes at least a number of links used for the TCP traffic of the STA MLD; and
transmitting the TCP traffic of the STA MLD based on the determined TCP transmission mode.

2. The method of claim 1, wherein identifying TCP traffic of an STA MLD to obtain a traffic behavior of the STA MLD comprises:
inspecting the TCP traffic between the AP MLD and the STA MLD;
obtaining, based on the inspection, the traffic behavior of the STA MLD; and
in response to obtaining the traffic behavior of the STA MLD, determining a size of the TCP traffic of the STA MLD.

3. The method of claim 1, wherein identifying TCP traffic of an STA MLD to obtain a traffic behavior of the STA MLD comprises:
setting, through custom commands, TCP session information with a latency requirement to obtain the traffic behavior information.

4. The method of claim 1, wherein estimating links between an AP MLD and the STA MLD to obtain link health information comprises:
determining, the number of links between the AP MLD and the STA MLD available for the TCP traffic; and
in response to determining the number of links, checking whether the links are proper for latency sensitivity traffic flow to obtain the link health information.

5. The method of claim 4, wherein estimating links between an AP MLD and the STA MLD to obtain link health information further comprises:
in response to determining the number of links, checking whether the links are proper for high-performance traffic flow to obtain the link health information.

6. The method of claim 1, wherein determining a TCP transmission mode for the STA MLD based on the traffic behavior of the STA MLD and the link health information comprises:
selecting, in response to the size of TCP traffic being less than a threshold, and the link health information indicating all other links being busy, a single link to transfer the TCP traffic and TCP acknowledgement (ACK).

7. The method of claim 6, wherein transmitting the TCP traffic of the STA MLD based on the determined TCP transmission mode comprises:
disabling an uplink Transaction Identifier (TID) of the TCP traffic of all other links through TID-to-link mapping negotiation; and
transmitting the TCP traffic and the TCP ACK on the selected link.

8. The method of claim 1, wherein determining a TCP transmission mode for the STA MLD based on the traffic behavior of the STA MLD and the link health information comprises:
selecting, in response to the TCP traffic being less than a threshold and the link health information indicating all links being not busy, at least two links to transmit the TCP traffic and TCP ACK.

9. The method of claim 8, wherein transmitting the TCP traffic of the STA MLD based on the determined TCP transmission mode comprises one of the following:
using the TID-to-link mapping negotiation to transmit the TCP traffic and TCP ACK on the at least two links selected;
using Transmission Opportunity (TXOP) sharing to transmit the TCP traffic and a TCP ACK on the at least two links selected; or
prioritizing scheduling of an uplink and a downlink of the TCP traffic and the TCP ACK on the selected at least two links.

10. The method of claim 1, wherein determining a TCP transmission mode for the STA MLD based on the traffic behavior of the STA MLD and the link health information comprises:
selecting, in response to the TCP traffic being greater than the threshold or the link health information showing all links being busy, all available links to transmit the TCP traffic and TCP ACK.

11. The method of claim 10, wherein transmitting the TCP traffic of the STA MLD based on the determined TCP transmission mode comprises at least one of the following:
releasing some restrictions for the TID-to-link mapping on both directions; and
using an application for quality of service (QOS) control.

12. The method of claim 1, wherein the AP MLD is an AP Multi-Link Single Radio (MLSR) or an AP Enhanced Multi-Link Single Radio (EMLSR), and transmitting the TCP traffic of the STA MLD based on the determined TCP transmission mode comprises at least one of the following:
indicating fake data buffer via Traffic Indication Map and Enhanced Distributed Channel Access (TIM IE) in beacon frames on a working link to make sure the working link being used during a TCP session transmission; or
disabling other links through TID-to-link mapping to avoid link switching time and reduce the TCP traffic latency.

13. An access point (AP) multi-link device (MLD) comprising:
at least one processor; and
a memory coupled to the at least one processor, the memory storing instructions to cause the at least one processor to:
identify Transmission Control Protocol (TCP) traffic of a station (STA) Multi-Link Device (MLD) to obtain a traffic behavior of the STA MLD, wherein the traffic behavior of the STA MLD includes at least size evaluation of the TCP traffic of the STA MLD;
estimate links between the AP MLD and the STA MLD to obtain link health information, wherein the link health information includes at least a number of links and whether the links are proper for latency sensitivity traffic flow;
determine a TCP transmission mode for the STA MLD based on the traffic behavior of the STA MLD and the link health information, wherein the TCP transmission mode includes at least a number of links used for the TCP traffic of the STA MLD; and
transmit the TCP traffic of the STA MLD based on the determined TCP transmission mode.

14. The AP MLD of claim 13, wherein identify TCP traffic of an STA MLD to obtain a traffic behavior of the STA MLD comprises:
inspecting the TCP traffic between the AP MLD and the STA MLD;
obtaining, based on the inspection, the traffic behavior of the STA MLD; and
in response to obtaining the traffic behavior of the STA MLD, determining a size of the TCP traffic of the STA MLD.

15. The AP MLD of claim 13, wherein identify TCP traffic of an STA MLD to obtain a traffic behavior of the STA MLD comprises:
setting, through custom commands, TCP session information with a latency requirement to obtain the traffic behavior information.

16. The AP MLD of claim 13, wherein estimate links between an AP MLD and the STA MLD to obtain link health information comprises:
determining, the number of links between the AP MLD and the STA MLD available for the TCP traffic; and
in response to determining the number of links, checking whether the links are proper for latency sensitivity traffic flow to obtain the link health information.

17. The AP MLD of claim 13, wherein determine a TCP transmission mode for the STA MLD based on the traffic behavior of the STA MLD and the link health information comprises:
selecting, in response to the size of TCP traffic being less than a threshold, and the link health information indicating all other links being busy, a single link to transfer the TCP traffic and TCP acknowledgement (ACK).

18. The AP MLD of claim 13, wherein determine a TCP transmission mode for the STA MLD based on the traffic behavior of the STA MLD and the link health information comprises:
selecting, in response to the TCP traffic being less than a threshold and the link health information indicating all links being not busy, at least two links to transmit the TCP traffic and TCP ACK.

19. The AP MLD of claim 13, wherein determine a TCP transmission mode for the STA MLD based on the traffic behavior of the STA MLD and the link health information comprises:
selecting, in response to the TCP traffic being greater than the threshold or the link health information showing all links being busy, all available links to transmit the TCP traffic and TCP ACK.

20. A non-transitory computer-readable medium comprising instructions stored thereon which, when executed by an access point (AP) multi-link device (MLD), cause the AP MLD to:
identify Transmission Control Protocol (TCP) traffic of a station (STA) Multi-Link Device (MLD) to obtain a traffic behavior of the STA MLD, wherein the traffic behavior of the STA MLD includes at least size evaluation of the TCP traffic of the STA MLD;
estimate links between the AP MLD and the STA MLD to obtain link health information, wherein the link health information includes at least a number of links and whether the links are proper for latency sensitivity traffic flow;
determine a TCP transmission mode for the STA MLD based on the traffic behavior of the STA MLD and the link health information, wherein the TCP transmission mode includes at least a number of links used for the TCP traffic of the STA MLD; and
transmit the TCP traffic of the STA MLD based on the determined TCP transmission mode.
